(19) United States
(12) Patent Application Publication
(10) Pub. No.: US 2011/0246551 A1
(43) Pub. Date: Oct. 6, 2011

(54) ADAPTIVE MULTIFUNCTION MISSION SYSTEM

(75) Inventors: Carlo Giancaspro, Sacrofano (IT); Francesco Fedi, Monterotondo (IT); Roeeo De Matteis, Cutrofiano (IT); Sante Candia, Fonte Nuova (IT)

(73) Assignee: Space Software Italia S.p.A., Taranto (IT)

(21) Appl. No.: 12/665,869

(22) PCT Filed: Jun. 20, 2008
(86) PCT No.: PCT/IB08/01624

§ 371 Date: Jun. 10, 2011

(30) Foreign Application Priority Data
Jun. 21, 2007 (IT) RM2007A000347

(51) Int. Cl. G06F 15/16

(52) U.S. Cl. 709/202

(57) ABSTRACT

The present invention concerns a mission system that comprises at least an operator station suitable for being operated by a human operator, at least a mission agent suitable, in use, for being used to carry out an operational mission and a mission control system. The mission control system comprises a server mission software module operatively coupled to the operator station and a client mission software module operatively coupled to the mission agent. The server mission software module is suitable, in use, for being operated by a human operator to define the operational mission by means of a mission plan comprising at least one mission activity to be carried out and at least one operating rule for carrying out the mission activity. The server mission software module is also able, in use, to communicate the mission plan to the mission agent. The client mission software module comprises at least a behaviour rule to be respected in order to carry out the mission activity and is able, in use, to receive the mission plan and to make the mission agent carry out the mission activity according to the operating rule and the behaviour rule.

### PRIORITY

This application claims priority under 35 USC 365 to PCT application no. PCT/IB2008/001624 filed on Friday, Jun. 20, 2008, which is incorporated herein by reference in its entirety.

### TECHNICAL SECTOR OF INVENTION

The present invention concerns an adaptive and multifunction mission system.

In particular, the present invention finds advantageous, but not exclusive, application in missions that need to be carried out by closely interacting and cooperating agents, such as clearing land of explosive devices and mines for example, to which the following description makes explicit reference purely by way of example.

### STATE OF THE ART

As is known, to carry out operations that are potentially risky for man, automated mission systems are nearly always used nowadays, i.e. mission systems that allow the deployment of men to be reduced to a minimum by using automated and/or remote-controlled devices.

These systems are generally formed by nodes and one or more operator stations.

In particular, the nodes can be fixed or mobile, can include one or more sensors and/or one or more actuators to carry out simple tasks, or can be robots equipped with artificial intelligence, sensors and/or actuators and be able to carry out very complex tasks autonomously.

Therefore, generalizing, the nodes can be provided with artificial intelligence and thus be able to carry out activities autonomously, or not be provided with artificial intelligence and thus be remotely controlled by a human operator via an operator station.

Thus, in known mission systems, an operator station generally allows a human operator to control and coordinate the activities of the nodes and, in particular, to oversee the work environment via the information received from the sensors, to remotely pilot the actuators, making them perform specific actions, and, if necessary, to also override their artificial intelligence and control them remotely.

Hence, in conclusion, the nodes in known mission systems are connected to each other insufficiently or indirectly and any possible reciprocal interaction is never direct, but always via the operator station.

### SUBJECT AND ABSTRACT OF THE INVENTION

The Applicant has noted how every interaction between the nodes in known mission systems is always by means of the operator station.

This fact results in several drawbacks.

A first drawback is represented by the difficult reconfigurability of the system as it grows in size. In fact, as the number of nodes grows, the operator station needs ever-increasing resources for managing the modified system.

A second drawback is represented by poor reliability. In fact, given their hierarchical nature, known mission systems have a precise critical point, represented by the operator station. In fact, as the activities intensify, in terms of the number and complexity of the functions to be performed, a large workload becomes concentrated on the operator station and, in consequence, the risk increases of an error and/or failure occurring.

From what has just been described, a further problem of known mission systems can be immediately seen, i.e. the high vulnerability to failures and/or errors. In fact, the high numeric concentration and complexity of the functions in a single point of the mission system makes that point, or rather the operator station, and hence the entire mission system that is based upon it, even more subject to failures and faults caused by errors.

Furthermore, another problem of known mission systems derives from their difficult reconfigurability and reliability, i.e. the difficult adaptability to dynamic scenarios. In fact, in a dynamic and unpredictable operating environment, it is very likely that unexpected load and/or operating conditions can arise, with consequent performance degradation of the mission system or the inability to carry out the functions due to overload of the single point of information handling, i.e. the operator station.

Lastly, a further problem of known mission systems consists in their poor maintainability. In fact, the high numeric concentration and complexity of the functions entrusted to the operator station also entails an increase in both corrective and development maintainability of the operator station and therefore of the entire mission system that is based upon it.

From the above, it is evident that even though the known art offers mission systems equipped with intelligent nodes, these suffer from quite specific problems due to the hierarchical nature that characterizes them and that aims at concentrating almost all of the vital functions in a few nodes.

Thus, objective of the present invention is to provide a mission system that is able to overcome the above-mentioned drawbacks.

This objective is achieved by the present invention in that it relates to a mission system, a mission control system and mission software modules, as defined in the appended claims.

### BRIEF DESCRIPTION OF DRAWINGS

For a better understanding of the present invention, some preferred embodiments, provided purely by way of non-limitative example, shall now be explained with reference to the enclosed drawings (not all to scale), wherein:

FIG. 1 shows a mission system according to the present invention,

FIG. 2 shows logical structure of a software component of the mission system in FIG. 1,

FIG. 3 shows a block diagram that illustrates the functioning and reciprocal entity interaction of the software component in FIG. 2, and

FIG. 4 shows an example of data distribution between entities of the software component in FIG. 2.

### DETAILED DESCRIPTION OF PREFERRED EMBODIMENTS OF THE INVENTION

The following description is provided to allow an expert in the field to make and use the invention. Various modifications to the embodiments shown will be immediately obvious to experts and the generic principles explained herein could be applied to other embodiments and applications, without however departing from the scope of protection of the present invention.

Therefore, the present invention should not be intended as limited to just the embodiments shown and described herein, but be given the broadest scope of protection consistent with the principles and characteristics presented herein and defined in the appended claims.

Furthermore, the present invention is also embodied by means of mission software modules, as described in the following and defined in the enclosed claims.

A mission system according to the present invention comprises at least one operator station, which in turn comprises at least an electronic processor destined to be used by a human operator and connected to communication means. The electronic processor can, for example, be a desktop computer, a laptop, a tablet Personal Computer (PC) or a Personal Digital Assistant (PDA).

For expediency, the operator station can also include motion actuators that allow the operator station to move.

On the other hand, the operator station can also usefully include sensors and/or specific actuators according to the task or tasks that it wished the operator station be able to perform.

Furthermore, the mission system according to the present invention comprises at least one agent or node, i.e. a device comprising electronic and/or mechanical and/or software and/or chemical technologies according to the task or tasks for which the agent has been constructed. Thus, the agent comprises motion actuators and/or sensors and/or specific actuators based precisely on the task or tasks for which the agent has been designed and constructed. The agent is defined as mobile or fixed according to whether or not it comprises motion actuators.

Furthermore, the agent also comprises communication means and processing means.

For clarity of description, some non-limitative examples are provided below of motion actuators, sensors and specific actuators that can be incorporated by the operator station and by the agent.

Examples of motion actuators can include electric motors, or combustion or hybrid engines connected to wheels and/or caterpillar tracks for overland travel, electric motors, or combustion or hybrid engines connected to propellers or jet engines for flying, electric motors, or combustion or hybrid engines connected to propellers for marine navigation, etc.

In addition, examples of sensors can include digital cameras, radar, smoke detectors, seismographs, rain sensors, temperature sensors, pressure sensors, humidity sensors, position detectors, such as GPS receivers for example, etc.

Lastly, examples of specific actuators can include means for clearing trees, means for probing the ground, firefighting means, means of suction, etc.

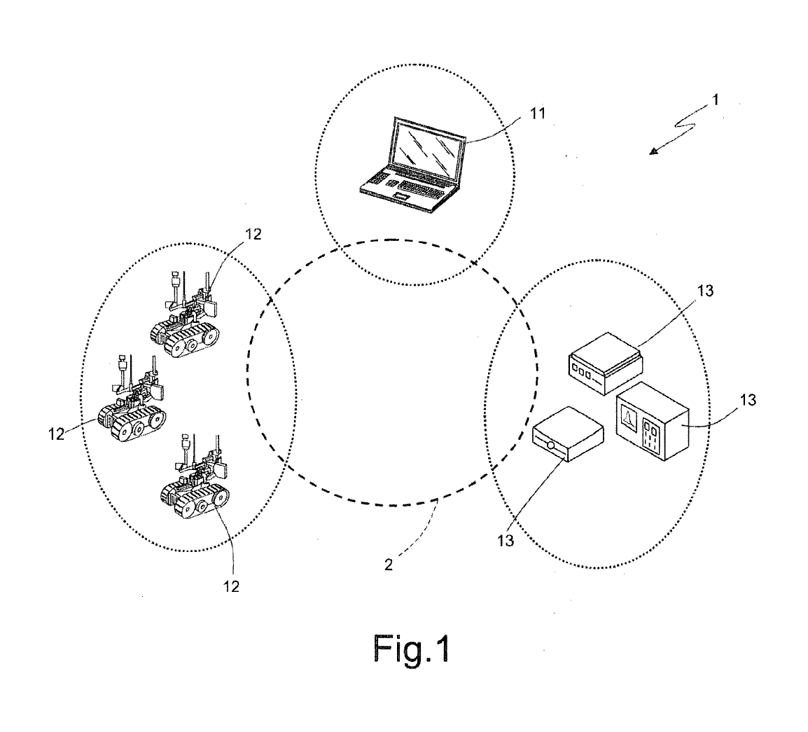

Always for clarity of description, an example of embodiment of the mission system according to the present invention is shown in FIG. 1.

In particular, the mission system 1 shown in FIG. 1 comprises a first operator station 11 consisting of a laptop computer, several mobile agents 12 and several fixed agents 13.

Each mobile agent 12 and each fixed agent 13 is individually identifiable from the operator station 11 and is able to autonomously operate, pilot and use the sensors, the specific actuators and, if necessary, the motion actuators with which it is equipped.

Furthermore, always as shown in FIG. 1, the mission system 1 also comprises a mission control system 2 which is software-implemented and coupled to the operator station 11, the mobile agents 12 and the fixed agents 13.

In particular, amongst the various characteristics of the mission control system 2 that shall be described in detail further on, it is wished to point out a fundamental one here: the mission control system 2 provides the agents 12 and 13 with the capability of coordinating their activities for the purposes of carrying out a given mission, whilst maintaining the autonomy and specificity of the individual agents 12 and 13.

In fact, if on one hand the operational autonomy of the agents and 13 allows highly specialized agents to be made for performing special tasks, on the other hand, if a coordination capability could not be guaranteed for the activities of the individual agents 12 and 13, the operational autonomy could represent a limit on the utilization of the mission system 1 when several agents 12 and 13 are assigned the same task.

Therefore, from what has just been said, it can be understood how the mission control system 2 is a fundamental element of the mission system 1 and, more in general, of the present invention.

Hence, it is stressed that the agents 12 and 13 are able to carry out the tasks they are assigned as a team of cooperating agents, because they are coupled to the mission control system 2. The cooperation capability provided by the mission control system 2 and that of diversified specialization allow the mission system 1 to adapt itself to the specific nature of the single cases that arise in carrying out the mission to be completed. The agents 12 and 13 act as one or more operations teams that coordinate themselves in carrying out a specific mission assigned to them by the operator. Each single operations team will dynamically equip itself with the instruments and functions that allow it to perform the assigned activity in the most efficient manner.

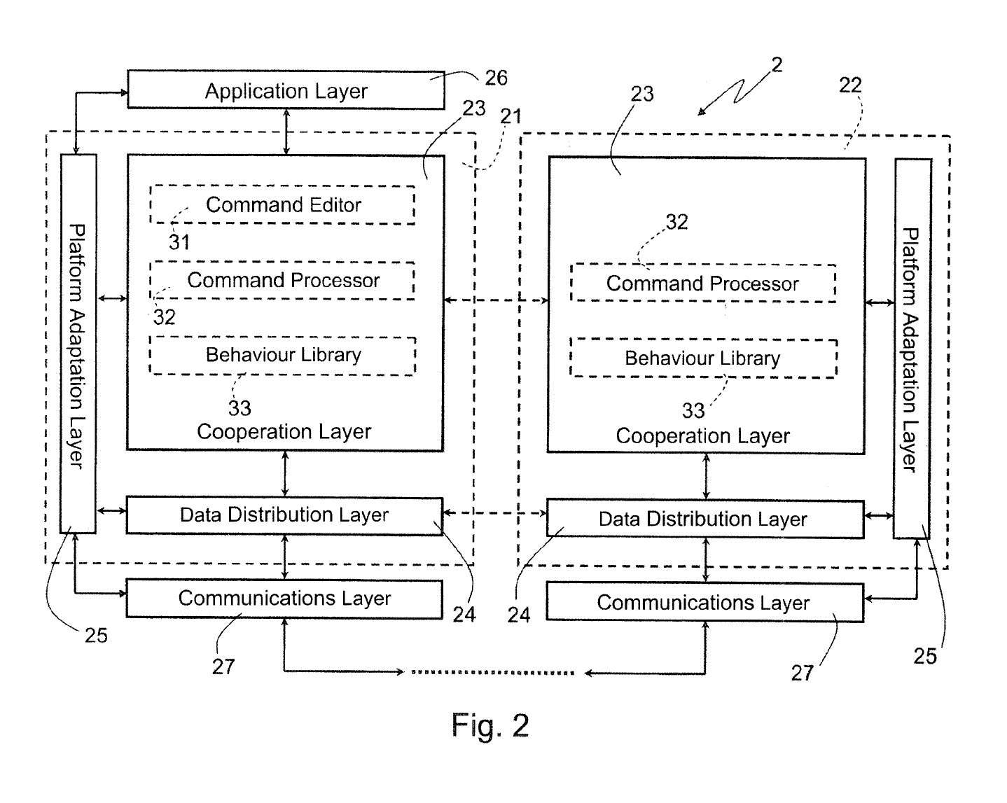

In particular, the mission control system 2 consists of software modules having a logical stack structure. The logical stack structures of these software modules are shown in FIG. 2.

In detail, as shown in FIG. 2, the mission control system 2 comprises a server mission software module 21 installed and executed on the operator station 11, in particular executed by the electronic processor of the operator station 11, and a client mission software module 22 installed and executed on the mobile agents 12 and on the fixed agents 13, in particular executed by the processing means of the mobile agents 12 and the fixed agents 13.

In particular, always as shown in FIG. 2, the logical stack structure of the server mission software module 21 is inserted below an application layer 26 and above a communications layer 27 of the logical stack structure of the electronic processor of the operator station 11.

In addition, the logical stack structure of the client mission software module 22 is inserted above the communications layer 27 of the logical stack structure of the processing means of the mobile agents 12 and the fixed agents 13.

In particular, mission monitoring and control software applications run at the application layer 26.

Instead, the communications layer 27 hosts the telecommunications protocols, or rather, typically, interface libraries to the communication means of the operator station 11, the mobile agents 12 and the fixed agents 13.

In addition, always as shown in FIG. 2, both the logical stack structure of the server mission software module 21 and the logical stack structure of the client mission software module 22 include an upper layer, called cooperation layer 23, and a layer called data distribution layer 24, which is located below the cooperation layer 23 and above the communications layer 27.

In the present invention, as in any stack model, typical in the telecommunications and computer environment, entities working at the same levels, or rather at the same layers of different nodes in the modelled infrastructure, also communicate with each other.

In other words, an entity that works at the level of the cooperation layer 23 of a server mission software module 21 or of a client mission software module 22, externally to the server mission software module 21 or the client mission software module 22, communicates and exchanges information with entities that always work at the level of the cooperation layer 23 of other server mission software modules 21 and other client mission software modules 22, but not with entities that work at the level of the data distribution layer 24 of other server mission software modules 21 or other client mission software modules 22.

In the same way, an entity that works at the level of the data distribution layer 24 of a server mission software module 21 or of a client mission software module 22, externally to the server mission software module 21 or the client mission software module 22, communicates and exchanges information with entities that always work at the level of the data distribution layer 24 of other server mission software modules 21 and other server client mission software modules 22, but not with entities that work at the level of the cooperation layer 23 of other server mission software modules 21 or other client mission software modules 22.

The communication and exchange of information between entities working at the same levels is represented in FIG. 2 by the dashed arrow that connects the cooperation layers 23 of the server mission software module 21 and the client mission software module 22 together, and by the dashed arrow that connects the data distribution layers 24 of the server mission software module 21 and the client mission software module 22 together.

Naturally, always as in any telecommunications or computer stack model, communications between entities working at the same levels is implemented and embodied through a “vertical” exchange of data in each node, namely inside the server mission software module 21 and the client mission software module 22.

In detail, as indicated in FIG. 2 by the solid arrows, this “vertical” data exchange is bidirectional and takes place in the server mission software module 21 between the application layer 26 and the cooperation layer 23, between the cooperation layer 23 and the data distribution layer 24, and between the data distribution layer 24 and the communications layer 27; whilst in the client mission software module 22 it takes place between the cooperation layer 23 and the data distribution layer 24, and between the data distribution layer 24 and the communications layer 27.

Therefore, when a first entity at the level of the cooperation layer 23 of a first node logically communicates with a second entity at the same level of a second node, in the first node data travels bidirectionally between the cooperation layer 23, the data distribution layer 24 and the communications layer 27, between the first and the second node data is transmitted bidirectionally via the communication means between the respective communications layers 27, and in the second node data travels bidirectionally between the cooperation layer 23, the data distribution layer 24 and the communications layer 27.

In addition, both the logical stack structure of the server mission software module 21 and the logical stack structure of the client mission software module 22 can also conveniently include a platform adaptation layer 25, which, as shown in FIG. 2, is not stacked on the logical stack structure in the prescribed manner, but is a transversal layer with respect to the other two layers of the stack, namely the cooperation layer 23 and the data distribution layer 24.

In detail, interface entities work at the platform adaptation layer 25 that render the server mission software module 21 and the client mission software module 22 independent of the type of hardware and/or software platform to which they are coupled, or rather that allow the coupling of the mission control system 2 to any node of the mission system 1, taking into account the specificity of that node, i.e. any type of operator station 11, any type of mobile agent 12 and any type of fixed agent 13.

In fact, the platform adaptation layer 25 functions as an interface between the server mission software module 21, the client mission software module 22 and the motion actuators, sensors and specific actuators of the hardware and/or software platform to which they are coupled. In particular, the platform adaptation layer 25 functions as an interface between the cooperation layer 23, the data distribution layer 24 and the hardware and/or software platform.

In FIG. 2, the possibility is also shown of data exchange between the cooperation layer 23 and the application layer 26 and of data exchange between the data distribution layer 24 and the communications layer 27 being effected via the platform adaptation layer 25.

The software entities that work at the level of the cooperation layer 23 shall now be described in detail.

In particular, software entities work at the level of the cooperation layer 23 that allow the mobile agents 12 and the fixed agents 13, and also the operator station 11, to behave in a reciprocally cooperative manner for carrying out the mission in a manner consistent with their respective typologies and respective functionality.

As shown in FIG. 2, the server mission software module 21 at the level of the cooperation layer 23 comprises a command editor 31 and, expediently, also a command processor 32 and a behaviour library 33, while the client mission software module at the level of the cooperation layer 23 comprises a command processor 32 and a behaviour library 33.

In detail, by means of a user interface, the command editor 31 allows a human operator to:

form operations teams of agents 12 and 13 on the basis of their characteristics, or rather on the basis of the possible motion actuators, sensors and specific actuators with which they are equipped, and on the basis of the characteristics of the area where they must work and a specific mission that they must perform,

define the specific mission to be performed by each operations team in terms of activities to be carried out and their interdependencies, and

define operating policies or rules to be respected whilst carrying out the activities.

In detail, the command editor 31 enables the definition of the specific mission in terms of command sequences able to define each specific activity that must be carried out by the operations team within the scope of the overall mission that the mission system 1 must accomplish.

The command sequence represents a syntactic construct to define the operations team's response. The commands can usefully be described in the XML language.

In addition, the command editor 31 allows a human operator to dynamically change the commands given to each operations team and even those given to each individual agent 12 or 13.

Instead, the command processor 32 enables each agent 12 or 13 to correctly execute the commands within its area of competence in order to carry out the specific mission assigned to the operations team of which it is part.

In detail, the command processor 32 acquires the rules and the commands regarding the activity to be carried out and then executes them by making use of the behaviour library 33.

The rules and commands are executed taking into account the current operational and environmental conditions, and therefore their execution is context sensitive.

The execution of rules and commands is based on an Event-Condition-Action (ECA) paradigm, which distinguishes between the following concepts:

event, the occurrence of which entails the activation of the rule and/or command,

condition, the checking of which entails the possible execution of the rule and/or command, and

action, namely the execution of the rule and/or command in terms of operation sequences, which only takes place if the condition is true.

An operation can be basic or behavioural, i.e. resident in the behaviour library 33.

By means of this paradigm, each agent 12 or 13 of the operations team:

acquires the events of the environment in which it works,

checks the consistency of the activities carried out with the current environmental conditions, and

carries out any behavioural or control actions.

Furthermore, the behaviour library 33 provides a series of base behaviours that can be adopted by the operations team depending on the current operational requirements. In fact, the behaviour library 33 defines the methods and means through which the operations team organizes itself to carry out the activities it is assigned with, adapting itself to the current operational requirements. An individual behaviour is defined by a sequence of rules that define the responses to external events of an agent 12 or 13 that covers a given role in the operations team. Events can be generated by the interaction of the agent 12 or 13 with the operational environment or with other components of the operations team. Similarly to what happens for the commands, behaviours can be dynamically loaded on the individual agent 12 or 13 according to the specific role these assume in the operations team.

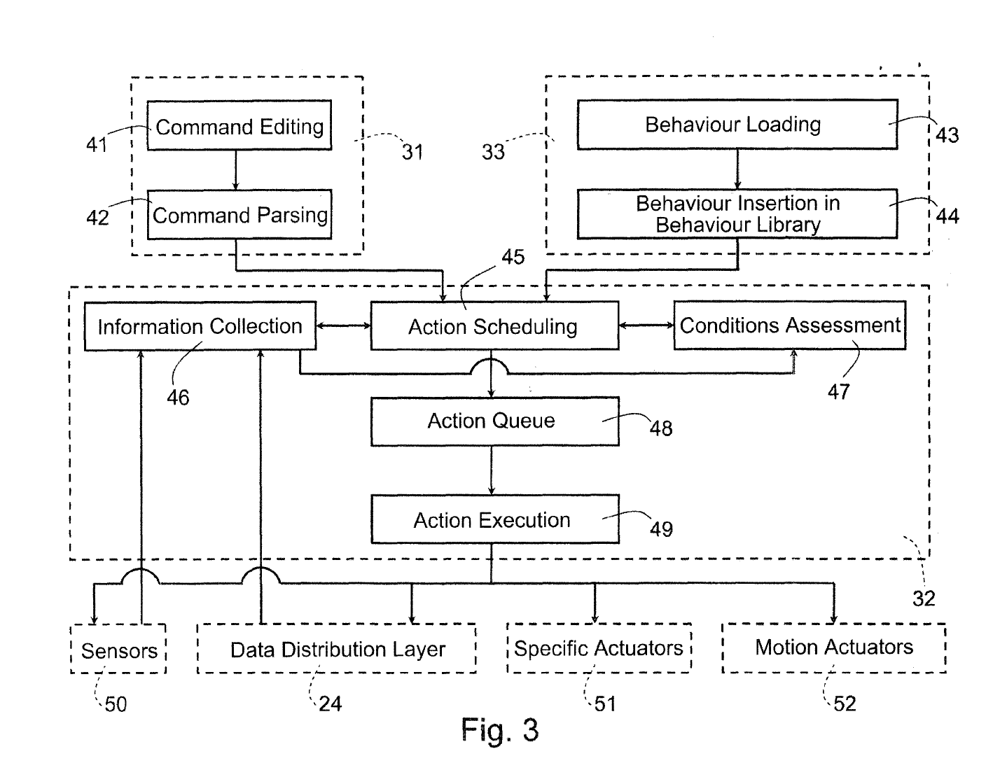

In particular, what has been said so far about the command editor 31, the command processor 32 and the behaviour library 33 is shown in FIG. 3, where a block diagram is provided that schematically represents the logical functioning and reciprocal interaction of the command editor 31, the command processor 32 and the behaviour library 33.

In detail, editing of the commands (block 41) by a human operator takes place via the user interface of the command editor 31. The command editor 31 then performs command parsing (block 42).

In addition, the behaviours are loaded (block 43) and inserted in the behaviour library 33 (block 44).

The command processor 32, as already mentioned, collects information on the environment in which the agent 12 or 13 to which it is coupled (block 46) works. This information can originate from sensors 50 that equip the agent 12 or 13 to which the command processor 32 is coupled, from other agents 12 and 13, or from the operator station 11 by means of the data distribution layer 24. This information represents the events of the Event-Condition-Action (ECA) paradigm, the verification of which entails the activation of the rule and/or command.

In addition, the command processor 32 assesses the consistency of the commands received from the command editor 31 and the behaviours received from the behaviour library 33 with the information on the environment in which it works, i.e. the current environmental conditions (block 47). Based on this assessment, the command processor 32 schedules one or more actions to be performed (block 45) and assigns them an execution priority on the basis of which they are inserted in the queue of actions to be carried out (block 48).

Finally, the command processor 32 performs the actions (block 49) according to the order of priority in which they are positioned in the queue. In particular, performing the actions (block 49) can consist in making specific information available to other agents 12 and 13 via the data distribution layer 24 and/or making the motion actuators 52, the specific actuators 51 and/or the sensors 50 that equip the agent 12 or 13 to which the command processor 32 is coupled perform specific actions.

For clarity of description, an example of the functioning of the software entities working at the level of the cooperation layer 23 of a client mission software module 22 coupled to a mobile agent 12 for tree clearing is now described. In addition to the motion actuators, this mobile agent 12 is equipped with a digital camera and tree-clearing means.

In detail, the command processor 32 of the client mission software module 22 coupled to the mobile agent 12 for tree clearing has received a command from the command editor 31 of the server mission software module 21 coupled to the operator station 11 to clear a certain area surrounding it. The behaviour library 33 of the client mission software module 22 coupled to the mobile agent 12 for tree clearing contemplates two actions for this command: clearing, if the surrounding vegetation is within reach of the tree-clearing means, and approaching the surrounding vegetation if it is not within reach of the tree-clearing means.

Therefore, the command processor 32 acquires photographs of its surrounding environment from the digital camera (block 46), assesses whether or not the surrounding vegetation is within reach of the tree-clearing means on the basis of these photographs (block 47) and, in consequence, either clears the surrounding environment (block 49) using the tree-clearing means or approaches the surrounding vegetation (block 49) using the motion actuators. In this particular, very simple case, the queue of the activities to be performed (block 48) is formed by two actions, namely approach the surrounding vegetation and clear it, the respective priorities of which are determined by the command processor 32 based on the distance between the tree-clearing means and the surrounding vegetation (block 47), evaluated on the basis of the acquired photographs (block 46).

The data distribution layer 24 shall now be described in greater detail.

In particular, both the server mission software module 21 and the client mission software module 22 include a data distribution software entity at the level of the data distribution layer 24 that allows the distribution of data and information within the mission system 1. This data and information distribution is based on the Publisher/Subscriber communication paradigm, a communication paradigm that is expressly devised for the distribution of data and information in a network of “peer” nodes, i.e. a network in which no node performs a service based on the request of another. When required, this information distribution can also take place with service quality guarantees.

In addition, as shall be shortly described in detail, the data distribution software entity allows selective diffusion of information, thanks to which an individual item of information is only supplied to those agents 12 or 13 and/or the operator station 11 that effectively needs it and at the moment in which this need arises. However, this happens without who uses the information having to know who provides it or where the source of this information is located, and without there being a need for the source of the information to know who the users are and where they are located.

In detail, a data distribution entity that has an available data item makes it public independently of the fact of whether or not someone is interested in this data, and where and who the parties interested in this data are.

Hence, the data item is rendered public by the data distribution entity, together with a “label” that describes the type of published data, by means of a characteristic Publisher for this data type.

Analogously, a data distribution entity that needs a specific type of data, requests this specific data type by means of a characteristic Subscriber for this specific data type. If a characteristic Publisher for this specific data type is present, then the Subscriber retrieves the data item from that Publisher.

In this way, the data distribution layer 24 is composed of a set of Publishers and Subscribers, the “types” of which vary according to the label of the data to be transmitted.

Only the simultaneous presence of one or more Publishers and one or more Subscribers related to the same data type results in the actual transmission of the data item via the communication means.

Given the presence of a certain type of Subscriber and the lack of a corresponding Publisher, or given the presence of a certain type of Publisher and the lack of a corresponding Subscriber, no data transmission will take place until the entity that is lacking appears on the data distribution layer 24.

The data distribution layer 24 is the foundation upon which peer cooperation between the agents 12 and/or 13 of the mission system 1 rests.

In fact, for its very conception, the data distribution layer 24 implements a peer-to-peer architecture.

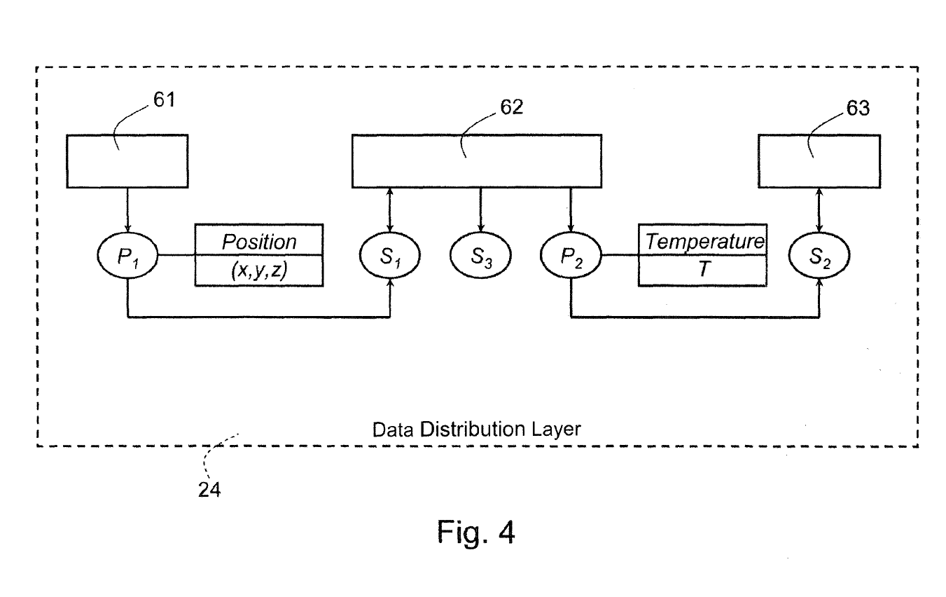

In particular, FIG. 4 shows an example of data distribution between data distribution entities at the level of the data distribution layer 24.

In detail, as shown in FIG. 4, a first data distribution entity 61 publishes a position (x,y,z) together with a POSITION label, which defines the type of data as actually being position data, via Publisher P₁ related precisely to position data.

A second data distribution entity 62 publishes a temperature T together with a TEMPERATURE label via a Publisher P₂ related precisely to temperature data. At the same time, the second data distribution entity 62 also requests pressure data via a Subscriber S₃ related precisely to pressure data, and position data via a Subscriber S₁ related precisely to position data.

In addition, a third data distribution entity 63 requests temperature data via a Subscriber S₂ related precisely to temperature data.

Therefore, as shown in FIG. 4 and in accordance with that just described regarding the data distribution layer 24, because Publisher P₁ and Subscriber S₁ are related to the same data type, namely position data, position (x,y,z) is transmitted from P₁ to S₁ and then retrieved by the second entity 62.

In the same way, temperature T is transmitted from P₂ to S₂ and then retrieved by the third entity 63.

Instead, as there is no Publisher related to pressure data in the distribution layer 24, Subscriber S₃ and therefore the second entity 62 continue to wait for the appearance of a Publisher P₃ related to this data type on the distribution layer 24.

A mine clearing system embodied according to the present invention is now described.

The mission of the mine clearing system is that of clearing an area contaminated with buried and/or aerial explosive devices. The mine clearing system substitutes the men who would have to operate directly in the minefield with teams of self-moving units, or robots, with different specializations, which operate in an autonomous and coordinated manner with objective of carrying out the various activities assigned to them by a human operator by means of a mission plan. The individual robots of each team cooperate with each other and with human operators in order to achieve the common goal of mine clearance, i.e. to identify and neutralize the explosive devices present in the area.

The mine clearing system comprises a plurality of robots, each equipped with communication means, processing means, sensors and/or motion actuators and/or specific actuators.

The mine clearing system also comprises operator stations, each of which is assigned to a specific activity.

There are two types of player in the operational scenario of the mine clearing system: human operators that, in various roles, plan, control and command the entire mine clearing mission, and robots, organized in teams that carry out those activities that are repetitive or too dangerous for human operators.

In particular, human operators can cover the following operational roles:

planner,

supervisor, and

bomb-disposal expert.

In detail, a human planner plans the mission for clearing the area of mines by defining a mission plan in which the following are defined:

the area to be cleared, characterized by the planimetric specifications such as, for example, boundaries, hazardous zones and/or obstacles not easily and autonomously identifiable by the robots, areas of vegetation, etc.,

the phases of the mission and the corresponding activities to be carried out,

the strategies for the phases of the mission and their mutual dependencies, and

the number of robot teams, the area of action of each team, the number and types of robots belonging to each team and the area of action of each robot.

In particular, the phases of the mission include a phase of probing the area to be cleared, in which the area to be cleared is probed by some of the robots forming part of the mine clearing system in order to locate explosive devices and signal their presence, and a phase of securing the area to be cleared with other robots forming part of the mine clearing system, in which the identified explosive devices are rendered inoffensive either by being exploded with an explosive charge or by separation of the detonator from the explosive material.

The probing phase comprises the following activities:

elimination of any areas of vegetation,

tactile probing to identify explosive devices via opportune tactile sensors with which specific robots are equipped,

supplementary probing of an object that is carried out by other specific robots equipped with sensors based on different detection technologies from the tactile one, for example, Ground Penetration Radar, in cases where the results provided by the robots with tactile sensors do not meet the minimum confidence requirements, and

auditing of the probed areas in order to check in a sure manner that there are no explosive devices left undetected by tactile probing and supplementary probing.

Instead, the securing phase comprises the following activities:

preparation of the area to be cleared for being freed of the explosive devices found, and

neutralization of the explosive devices via remotely controlled explosive charges made to explode by human operators using remote control.

At the end of the securing phase, the area is found to be clear of mines and the activities are considered terminated.

In addition, a human supervisor checks the results of the activities at overall level, at team level and at single-robot level, and controls the robots, both individually and at team level, modifying the mission assigned to them in real time. The level of control can vary up to the remote control of an individual robot.

Instead, a human bomb-disposal expert controls a team of robots and takes over the activities carried out by the robots in his/her team in cases where the achieved results do not guarantee the required level of confidence or the operational and/or environmental conditions are not suitable for the use of robots. The human operator who works in the role of a bomb-disposal expert can also use a specific robot locally to support his/her activity, e.g. a robot auditor to indicate a safe path to the zone where work must be carried out.

For each human operator there is a corresponding, specific operator station that supports the mission and the activities assigned to him/her.

Therefore, the mine clearing system includes the following operator stations:

a mission planning station suitable for being used by a human planner,

a mission control station suitable for being used by a human supervisor, and

a team control station for each team of robots suitable for being used by a human bomb-disposal expert.

In particular, the mission planning station comprises an electronic processor, communication means and, expediently, motion actuators and/or specific actuators and/or sensors.

Furthermore, the server mission software module 21 according to the present invention is installed and executed on the mission planning station's electronic processor, this module comprising:

the command editor 31 according to the present invention, through which a human planner defines the mission plan, and

the data distribution entity according to the present invention, suitable for acquiring information and data from the robots, the mission control station and the team control stations, and for selectively distributing the mission plan or parts thereof to the robots, the mission control station and the team control stations based on their respective roles and the respective activities to be carried out as defined in the same mission plan.

The mission control station comprises an electronic processor, communication means and, expediently, motion actuators and/or specific actuators and/or sensors.

Furthermore, the server mission software module 21 according to the present invention is installed and executed on the mission control station's electronic processor, this module comprising:

the command editor 31 according to the present invention, through which a human supervisor modifies the planned activities in order to adapt their execution to current operational requirements,

the command processor 32 according to the present invention, suitable for implementing the safety and secrecy policies, and the operating procedures defined for the mission to be controlled, and

the data distribution entity according to the present invention, suitable for acquiring information and data from the robots and the team control stations, and the mission plan from the mission planning station, and for selectively distributing information to the mission planning station and the commands and activities to be carried out to the robots and the team control stations.

Finally, the team control station comprises an electronic processor, communication means, and, expediently, motion actuators and/or specific actuators and/or sensors.

Furthermore, the server mission software module 21 according to the present invention is installed and executed on the team control station's electronic processor, this module comprising:

the command editor 31 according to the present invention, through which a human bomb-disposal expert defines the specific activities to be carried out and controls any motion actuators and/or specific actuators and/or sensors of the same team control station, as well as the robots of the controlled team, up to the point of remotely controlling them,

the command processor 32 according to the present invention, suitable for executing the specific activities and commands defined via the command editor 31 and for implementing the safety and secrecy policies and the operating procedures defined for the controlled team, and

the data distribution entity according to the present invention, suitable for acquiring information and data from the robots of the controlled team, the mission plan or specific parts thereof from the mission planning station and commands and activities to be carried out from the mission control station, and for selectively distributing information to the mission planning station and the mission control station and commands and activities to be carried out to the robots of the controlled team.

Furthermore, the role of each robot depends on the sensors, motion actuators and specific actuators with which the robot is equipped.

In particular, the robots can cover the following operational roles:

vegetation clearer,

prober,

supplementary research specialist,

bomb-disposal expert, and

auditor.

In detail, a robot able to clear vegetation, as is easily guessed, takes care of removing vegetation from the area to be cleared of mines where this vegetation is an obstacle to correctly carrying out the mine-clearing mission, and is equipped with specific actuators suitable for carrying out this type of activity.

A robot prober carries out pervasive scanning of the area to be cleared of mines by means of tactile sensors in order to detect likely objects and identify their precise nature. A robot prober is quite elementary and of low cost, which allows the mine clearing system to have a large number of robots with this role, in order to significantly shorten the duration of the tactile probing phase.

A robot supplementary research specialist is equipped with sensors capable of performing very sophisticated research with respect to that performed by a robot prober. A robot supplementary research specialist is a resource shared between the various teams of the mine clearing system.

A robot bomb-disposal expert is equipped for laying remotely controlled explosive charges suitable for the controlled explosion of the detected explosive devices. Finally, a robot auditor is able to guarantee the total absence of “False Negatives”, namely undetected explosive devices, and thus enables human passage in the area.

The robots that form the team coordinate themselves to achieve the common operational objective through the execution of the commands assigned to them and in virtue of the behaviour library 33, upon which these commands act.

The client mission software module 22 according to the present invention is installed and executed on the processing means of each robot, this module comprising:

the command processor 32 according to the present invention, for executing the activities assigned to it,

the behaviour library 33 according to the present invention, containing the base functions for its autonomy and for its coordination with the other robots of its own team, and

the data distribution entity according to the present invention, suitable for acquiring information and data from the robots of its own team, the mission plan or specific parts thereof from the mission planning station and the commands and activities to be carried out from the mission control station and the team control station, and for selectively distributing information and data to the mission planning station, the mission control station, the team control station and the robots of its own team.

However, specific integrations for the behaviour libraries 33, or even new behaviour libraries 33, can be dynamically and selectively distributed to the robots from the mission planning station, the mission control station and the team control station, via the data distribution layer 24.

From the preceding description, the advantages of the present invention can be immediately understood. It is wished, for example, to underline how the mission control system according to the present invention coupled to sensors and actuators not equipped with artificial intelligence and/or remote control broadens the possibilities of exploiting these sensors and actuators, transforming them into specialized nodes that cooperate with each other and that can be organized into independent and cooperating teams.

Furthermore, the mission system according to the present invention also presents the following innovative characteristics:

adaptability to the various operating conditions that can occur whilst carrying out the specific mission,

self-resilience of the operations team, or rather the inability of any agent or robot to carry out its functions will be compensated by the mission control system through reorganization of the mission system, and

self-configuration of the operations team, or rather the groups of agents or robots that cooperate for carrying out the mission vary in number and specialization according to the difficulties encountered in performing a given task.

Finally, as opposed to known mission systems, the mission system according to the present invention offers the following advantages:

high reconfigurability that derives from a completely peer-to-peer architecture in which the operating functions are distributed across the various nodes that form the mission system, and which allows the necessary operational performance to be achieved by simply instantiating more nodes to carry out a function that is considered critical or overloaded; in addition, the distribution of the operating functions between the various nodes of the mission system allows a large number of nodes that carry out simple yet pervasive functions to be instantiated and the sharing of those nodes that perform complex and therefore usually expensive functions,

high reliability, as the vital functions of the mission system are replicated in a segmented manner between the same operating nodes and so the loss of one or more nodes only results in deterioration of the operating function assigned to them, but not in the elimination of vital functions from the mission system,

high adaptability, as the distribution of the operating functions between the various specialized nodes of the mission system and the constant cooperation between them allows the dynamic allocation of elements to where the current operating needs are greatest,

high fault tolerance, as the distribution of both operating and vital functions is across a variety of highly-specialized nodes, each of low manufacturing complexity, this being a guarantee of low probability of error, and

high maintainability, deriving from the constructional simplicity of each single specialized node and the repeating of vital functions on the various nodes, which makes them very similar for the base characteristics and distinct for just their specialization; in addition, the constructional simplicity and the distribution of the operating functions also permits a highly modular mission system and hence easier development maintenance.

Finally, it is clear that various modifications can be made to the present invention, all falling within the scope of protection of the invention defined in the enclosed claims.

For example, the operator station of the mission system according to the present invention could be constituted by a database containing predefined mission plans. In this case, a human operator can select one or more of these mission plans via a user interface that are then distributed to the mission system's nodes by means of the data distribution layer.

1-23. (canceled)

24. Mission system (1) comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.

25. Mission system (1) according to claim 24, wherein said operating rule and said behaviour rule comprise conditions that must be met in order for the mission activity to be carried out by the mission agent (12, 13), and in which the client mission software module (22) is also able, in use, to check if the given conditions are met in order to allow the completion of said mission activity.

26. Mission system (1) according to claim 25, wherein the server mission software module (21) comprises a first software entity (31) suitable, in use, for being operated by a human operator via a user interface to define the mission plan and a second software entity able, in use, to make the mission plan public within the mission system (1) and to transmit the mission plan made public when requested; the client mission software module (22) comprising a third software entity able, in use, to request reception of the mission plan made public and the mission data made public within the mission system (1), to make the mission data generated by mission agent (11, 12) public within the mission system (1) and to transmit the mission data made public when requested; the client mission software module (22) also comprising a fourth software entity (32) able, in use, to check if the conditions are met on the basis of the mission data, and to make the mission agent (12, 13) carry out the mission activity respecting the operating rule and the behaviour rule.

27. Mission system (1) according to claim 26, wherein the server mission software module (21) and the client mission software module (22) both have a logical stack structure, the logical stack structure comprising a cooperation layer (23) and a data distribution layer (24) which is located in the logical stack structure below the cooperation layer (23), the first software entity (31) working at the cooperation layer (23) of the logical stack structure of the server mission software module (21) and being able, in use, to communicate with any software entity working at the cooperation layer (23), the second software entity working at the data distribution layer (24) of the logical stack structure of the server mission software module (21) and being able, in use, to communicate with any software entity working at the data distribution layer (24), the third software entity working at the data distribution layer (24) of the logical stack structure of the client mission software module (22) and being able, in use, to communicate with any software entity working at the data distribution layer (24), and the fourth software entity (32) working at the cooperation layer (23) of the logical stack structure of the client mission software module (22) and being able, in use, to communicate with any software entity working at the cooperation layer (23).

28. Mission system (1) according to claim 27, wherein the mission data generated by the mission agent (12, 13) comprises information on the state of the mission agent (12, 13) and on the environment in which the mission agent (12, 13) works, the second software entity also being able, in use, to request and receive the mission data.

29. Mission system (1) according to claim 28, wherein the first software entity (31) and the second software entity, in use, communicate with each other, and in which the third software entity and the fourth software entity, in use, communicate with each other.

30. System according to claim 29, wherein the first software entity (31) is also suitable, in use, to be operated by a human operator via the user interface to define the behaviour rule, and to provide the behaviour rule to the client mission software module (22).

31. Mission system (1) according to claim 30, wherein the logical stack structure also comprises a platform adaptation layer (25) that in the logical stack structure is transversal to the cooperation layer (23) and the data distribution layer (24), the platform adaptation layer (25) of the logical stack structure of the server mission software module (21) being able to couple the server mission software module (21) to the operator station (11), and the platform adaptation layer (25) of the logical stack structure of the client mission software module (22) being able to couple the client mission software module (23) to the mission agent (12, 13).

32. Mission system (1) according to claim 7, wherein the mission agent (12, 13) is equipped with at least a sensor able to supply information on the environment in which the mission agent (12, 13) works to the fourth software entity (32).

33. Mission system (1) according to claim 30, wherein the mission agent (12, 13) is equipped with at least an actuator able to carry out the mission activity.

34. Mission system (1) according to claim 30, wherein the mission agent (1.2) is equipped with at least a motion actuator.

35. Mission system (1) according to claim 30, wherein the server mission software module (21) comprises at least a behaviour rule and a fifth software entity (32) able, in use, to make the operator station (11) carry out the mission activity respecting the operating rule and the behaviour rule.

36. Mission system (1) according to claim 35, wherein the operator station (11) is equipped with at least a sensor able to supply information on the environment in which the operator station (11) works to the fifth software entity (32), the fifth software entity (32) checking if the conditions contained in the behaviour rule and the conditions contained in the operating rule are satisfied on the basis of the mission data and the information on the environment in which the operator station (11) works.

37. Mission system (1) according to claim 35, wherein the operator station (11) is provided with at least an actuator able to carry out the mission activity.

38. Mission system (1) according to claim 35, wherein the operator station (11) is provided with at least a motion actuator.

39. Mission system (1) according to claim 30, wherein the operator station (11) comprises an electronic processor on which the server mission software module (21) is installed and, in use, is executed, and wherein the mission agent (12, 13) comprises processing means on which the client mission software module (22) is installed and, in use, is executed.

40. Mission system (1) according to claim 30, wherein the mission agent (12, 13) is a robot.

41. Mission system (1) according to claim 30, comprising a plurality of mission agents (12, 13), and in which the behaviour rule also comprises at least one rule of cooperation between the mission agents (12, 13); the first software entity (31) also being suitable, in use, for being operated by a human operator via the user interface for defining the geographic characteristics of a region where the operational mission must be carried out, for creating teams of mission agents (12, 13), for defining the type and number of mission agents (12, 13) belonging to each team, and for assigning a respective mission plan and a respective portion of the region in which the operational mission is to be carried out to each team; the second software entity also being able, in use, to communicate the mission plan and the portion of the region corresponding to the team to which the mission agent (12, 13) belongs to every mission agent (12, 13); the fourth software entity (32) also being able, in use, to make the mission agent (12, 13) carry out the mission activity in the respective portion of the region.

42. Mission control system (2) that can be coupled to a mission system (1), the mission control system (2) comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.

43. Server mission software module (21) for a mission system, the mission system comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.

44. Client mission software module (22) for a mission system, the mission system comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.

45. Electronic processor on which a server mission software module (21) is installed and, in use, is executed, the mission system comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.

46. Processing means on which a client mission software module (22) is installed and, in use, is executed, the processing means for a mission system (1), the mission system comprising:
at least an operator station (11) suitable for being operated by a human operator,
at least a mission agent (12, 13) suitable for being used to carry out an operational mission, and
a mission control system (2),
the mission system (1) being characterized in that the mission control system (2) comprises a server mission software module (21) operatively coupled to the operator station (11) and a client mission software module (22) operatively coupled to the mission agent (12, 13); the server mission software module (21) being suitable, in use, for being operated by a human operator to define the operational mission via a mission plan comprising at least a mission activity to be carried out and at least an operating rule to carry out the mission activity, the server mission software module (21) also being able, in use, to communicate the mission plan to the mission agent (12, 13); and the client mission software module (22) comprising at least a behaviour rule to be respected in order to carry out the mission activity and being able, in use, to receive the mission plan, the client mission software module (22) also being able, in use, to make the mission agent (12, 13) carry out the mission activity according to the operating rule and the behaviour rule.
